(19) United States
(12) Patent Application Publication
(10) Pub. No.: US 2011/0278460 A1
(43) Pub. Date: Nov. 17, 2011

(54) METHOD AND APPARATUS FOR DETERMINING THE COKE GENERATION TENDENCY OF HYDROCARBONS

(75) Inventor: Marco Respini, Casalmorano (IT)

(73) Assignee: BAKER HUGHES INCORPORATED, HOUSTON, TX (US)

(21) Appl. No.: 13/101,743

(22) Filed: May 5, 2011

Related U.S. Application Data
(60) Provisional application No. 61/334,279, filed on May 13, 2010.

(51) Int. Cl. G01N 21/35; G01J 5/02

(52) U.S. Cl. 250/340; 250/343

(57) ABSTRACT

Near IR spectroscopy may be used for determining the coke generation tendency of a hydrocarbon. The coke generation tendency of hydrocarbons may be used to control refining conditions. An apparatus for determining the coke generation tendency of hydrocarbons comprising a near infrared spectrophotometer and other components may be used to make the determinations continuously.

### CROSS REFERENCE TO RELATED APPLICATIONS

This application is claims priority from U.S. Provisional Patent Application Ser. No. 61/334,279 filed on May 13, 2010 the disclosure of which is incorporated herein by reference in its entirety.

### BACKGROUND

1. Field of the Invention

This disclosure relates to a method for determining the coke generation tendencies of hydrocarbons and the use of this determination for controlling refining process conditions. This disclosure particularly relates to a method for determining the coke generation tendencies of hydrocarbons and using that determination during cracking processes.

2. Background of the Art

Petroleum coke is a solid high carbon material that is produced, usually as a by-product, of an oil refining process. During such an oil refining process, crude oil may be distilled down into products such as kerosene, diesel fuel, jet fuel, gasoline, home heating oil, other fuel oils, and asphalt. Heavier products like asphalt tend to fall to the bottom. Indeed, the petroleum industry often refers to these heavier by-products as “heavy fractions” or “bottoms.”

When the heavy fractions are refined to the point of being almost pure carbon, they are referred to as coke. This high purity coke is a very useful material. It can, of course, be a high BTU low ash fuel. It also can be a source of carbon in applications such as the aluminum and steel production industries.

Even though coke is a valuable product, the unexpected production of coke at a point in a process not designed to handle solids can lead to problems with refinery production equipment. For example, generation of coke in a furnace can lead to fouling of heat exchanger surfaces. It would be desirable in the art of refining hydrocarbons to avoid unexpected production of coke.

### SUMMARY OF THE INVENTION

In one aspect the invention is a method for determining the coke generation tendency of hydrocarbons and using the coke generation tendency to control refining conditions wherein the determining of the coke generation tendency is performed using a near infrared spectrophotometer to analyze the concentration of asphaltenes in at least two solvent fractionation components. Coke is commonly defined as toluene insoluble fraction in refining products.

In another aspect the invention is an apparatus for determining the coke generation tendency of hydrocarbons comprising a near infrared spectrophotometer.

In still another embodiment, the invention is a computer method for determining the coke generation tendency of hydrocarbons and using the coke generation tendency to control refining conditions wherein the determining of the coke generation tendency is performed using a near infrared spectrophotometer to analyze the concentration of asphaltenes in at least two solvent fractionation components.

### BRIEF DESCRIPTION OF THE DRAWINGS

For a detailed understanding of the present invention, reference should be made to the following detailed description, taken in conjunction with the accompanying figures wherein:

FIGS. 1-5 are graphical representations of the data generated in Examples 1 and 2; and

FIG. 6 is a block diagram of a device for determining the coke generation tendency of hydrocarbons.

### DESCRIPTION OF THE PREFERRED EMBODIMENTS

In one aspect the invention is method for determining the coke generation tendency of hydrocarbons and using the coke generation tendency to control refining conditions. Most hydrocarbon molecules can be easily separated or transformed through thermal and chemical processes. The transformation and separation, usually done on a large scale with creation and collection of the desired species is the process known popularly as a “refining” the material. At a refinery, the refinery employees utilized the equipment and infrastructure to take raw, naturally occurring material and refine it into one or more forms that are more commercially desirable. For example, in one part of the refining process, the heavier molecules found in bitumen can be split into lighter components such as gasoline and diesel. From a simplified perspective, the process of refining material involves heating and altering the composition of the fuel materials by distillation, breaking or cracking the longer molecules into shorter ones, driving the various species off as volatile components, and then collecting substances in the desired form.

Many refining processes produce coke. When hydrocarbons are heated above certain temperatures, they can reach a point at which some of the carbon atoms in a feed material bind together to form coke. Coke can be problematic because it is a very hard and relatively untransformable substance which usually binds to its container when formed.

Coking processes require careful handling. Such processes are often accomplished in a batch or semi-batch modality. In some embodiments, after coke has formed, the container is set apart to jackhammer or otherwise remove the coke from it! Because of its solid and difficult to handle nature, a true continuous process is difficult to achieve.

Cracking processes are well known in the art of refining crude oil and other chemical processes. Such processes include, but are not limited to those disclosed in U.S. Pat. Nos. 6,096,188; 5,443,715; and 5,215,649 which are fully incorporated herein by reference.

The hydrocarbon feeds that can be treated using the process of the disclosure include crude oil and intermediate refinery products resulting from the refining of crude oil. Exemplary of such materials are heavy oils, petroleum residua, coal tars, shale oils, asphalts, or the like. In the practice of the process of the disclosure, many products may be made including ethylene, gasoline, diesel fuel, other fuel oils, and, of course, coke.

Processes producing heavy oils and coke are often subject to fouling. For the purposes of this application, fouling is a condition wherein materials having a very high viscosity and mixtures of viscous materials and solids such as coke deposits accumulate within process equipment causing reduced operational efficiency or even shutting down the processing equipment. For example, when fouling occurs, it may cause transfer pipes to clog which in turn may require the unit where this occurs to reduce process throughput or even shut down the unit. Such slowdowns and shut downs often result in increased operating costs for the units affected and also any integrated units upstream or downstream of the affected unit.

In the practice of the method of the disclosure, a hydrocarbon, in many embodiments a heavy hydrocarbon is admixed with a paraffin solvent a quantity of paraffinic solvent sufficient to fully precipitate the asphaltenes present. Paraffins useful with the method of the disclosure include, but are not limited to: normal alkanes such as n-pentane, n-hexane, n-heptane, n-octane, and the like; and nonlinear alkanes such as methyl propane, ethyl propane, cyclopentane, cyclohexane, and the like. In addition to paraffinic solvents, any solvent known to those of ordinary skill in the art to be useful for precipitating asphaltenes from hydrocarbons can be used.

The amount of solvent used to precipitate the asphaltenes is selected to ensure that all or nearly all of the asphaltenes are collected for further analysis. For example, in one embodiment of the method of the disclosure, the volume amount of solvent used is at least 40 times the volume of sample being analyzed.

The precipitate asphaltenes may be collected using any means known to be useful to those of ordinary skill in the art. For example, in one embodiment of the method of the disclosure, the asphaltenes are collected on a filter. In some embodiments, after asphaltenes are precipitated using heptane, they are collected on a submicron filter. In other embodiments, the precipitated asphaltenes are allowed to “rest” for periods of an hour or longer. Asphaltenes collected on the filter are washed with precipitating paraffin in order to remove any entrained or co-precipitated non asphaltenic molecule.

Next, the precipitate asphaltenes are subjected to solvent fractionation using a fractionating solvent. The fractionating solvent includes an aromatic solvent component. Aromatic solvents useful with the method of the disclosure include, but are not limited to: benzene, toluene, xylene, ethyl benzene, and the like. Any aromatic solvent known to be useful to those of ordinary skill in the art for dissolving asphaltenes may be used with the method of the disclosure. Additionally, other types of solvents useful for dissolving asphaltenes may be used.

The precipitated asphaltenes are subjected to solvent fractionation by washing with a fractionating solvent which is an admixture of an aromatic solvent and a paraffinic solvent. Further, in the practice of the method of the disclosure, the precipitated asphaltenes are subjected to not one but at least two washings with the fractionating solvent and the two washings are done using fractionating solvents having different ratios of the aromatic solvent and paraffinic solvent. Also a part of the method, the first washing is done with the aromatic solvent component being at a lower concentration as compared to the second washing.

In one embodiment, the method may be practiced by first precipitating the asphaltenes and then washing the precipitated asphaltenes with a fractionating solvent having the following component ratios:
1^{st}: Heptane 15/Toluene 85
2^{nd}: Heptane30/Toluene 70
3^{rd}: Heptane50/Toluene 50
4^{th}: Hexane 75/Toluene 25
5^{th}: Hexane 90/Toluene 10
   The use of more or less washings is within the scope of the invention. Also, the same solvents may not necessarily be used. For example in some embodiments, the first two washings could be done using hexane and toluene, and then two additional washings can be done using different ratios of heptanes and xylene.

In another embodiment the asphaltenes precipitated are washed with a solvent having a high ratio of xylene to heptane. This solvent will extract a large fraction of the total asphaltenes content leaving on the filter only those asphaltenes closest to the toluene insoluble fraction of the sample, commonly reported as coke. In a one embodiment a ratio of 90% xylene/10% of heptane is used, but all the ratios of xylene/heptane are within the scope of invention. The filter is washed with xylene; after the extraction with the xylene/heptane selected solvent, in order to extract all the remaining asphaltenes that are the narrow fraction closer to coke in terms of solubility properties. The amount of asphaltenes extracted by washing the filter with xylene is determined. The ratio of these asphaltenes with respect to total sample analyzed is an indicator of coking propensity. The ratio of the xylene extracted asphaltenes with respect to the sum of these asphaltenes plus the asphaltenes previously extracted by the selected xylene/heptane solvent, that is the total amount of asphaltenes in the sample, is another indicator of coking propensity.

In at least one embodiment of the method of the disclosure, a near infrared spectrophotometer is employed to make the subject determination of coking propensity by analyzing the concentration of asphaltenes in the fractionating solvent. This analysis may be performed using any method known to be useful of those of ordinary skill in the art. For example, in one embodiment, the fractionating solvent is scanned at a wavelength of from about 630 to about 1300 nm. Methods of analyzing for asphaltenes concentration in solvents utilizing external and/or internal standards are well known to those of ordinary skill in the art and may vary for each different type of machine and process.

In yet another embodiment, the method of the disclosure may be at least partially automated using an automatic titrator. An automatic titrator is used to dispense aliquots of fractionating solvent. An automatic titrator advantageously can dispense exact aliquots of fractionating solvents and, when networked with suitable equipment and a near infrared spectrophotometer, also make determinations of the contents of the samples so created. In an alternative embodiment, the automatic titrator and other equipment are networked to a controller. In many such embodiments, the controller is a personal computer.

In additional to making single determinations, the method of the disclosure, when coupled with the equipment described immediately above may be used continuously. In this embodiment, the amount of asphaltenes is measured for predetermined fractions on samples taken at predetermined intervals. The results are employed based upon prior experience or use of a predictive model to determine the coking tendency of the hydrocarbons being fed and the unit process parameters are changed or not, based upon the results. In an alternative embodiment of the method of the disclosure, a hydrocarbon feed is diverted when it reaches a predetermined point of coke generation tendency. In an alternative embodiment, the diverted hydrocarbon is treated with an additive to make it easier to process prior to being processed.

When the process parameters are changed, they may be changed in a way that allows the unit to handle a feed having more or less coking tendency. For example, in one embodiment of the method of the disclosure, when a hydrocarbon has a comparatively high coking tendency compared to the units present feed, it may be desirable to decrease temperatures or increase flow rates through parts of an operating unit. Process parameters may vary depending upon what type of unit is being operated. It is possible that in a separate unit, a hydrocarbon having a comparatively high coking tendendancy may require the opposite actions. Other process parameters include pressure, residence times, catalyst regeneration cycles and the like. Any process parameter known to be useful to those of ordinary skill in the art of operating a production may be changed or not changed as is appropriate to the effect of a change in coking tendency in the subject production unit.

In the practice of the invention, the density, type and opacity of the hydrocarbons to be evaluated will determine how the hydrocarbons will be tested. Those of ordinary skill in the art of running a cracking unit, for example, are knowledgeable regarding the methodology necessary to test their processes.

Still, generally, samples tested according to the invention may have sample sizes running from about 0.1 grams to about 5 grams. Typically, samples of hydrocarbons are heated to from about 45 to about 90° C. prior to testing to ensure complete dissolution of sample and of asphaltenes.

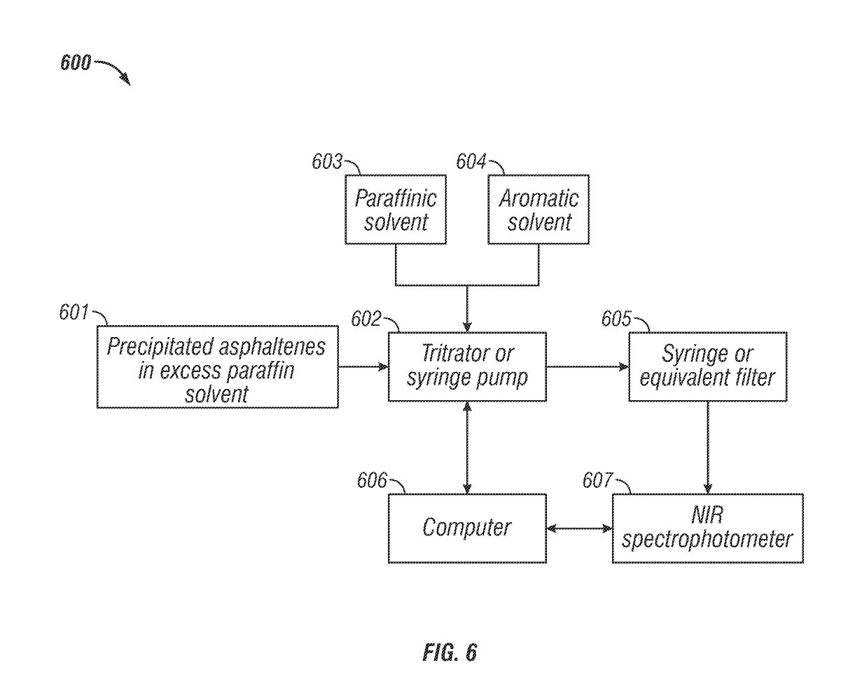

In one aspect, the invention is an apparatus for determining the coke generation tendency of hydrocarbons comprising a near infrared spectrophotometer. Turning to FIG. 6, one embodiment of the apparatus (600) is shown in block form. Precipitated asphaltenes in excess paraffin solvent (601) is placed in a container and the contents of the container are then subjected to filtration using a syringe filter or its equivalent (605). Then additional aliquots of a mixed solvents is delivered using a titrator or syringe pump to selectively extract from filter asphaltenes portions of different solubility. In some embodiments, especially when using an auto-titrator, a computer (606) may be present and used as a controller. The filtrate is then tested for asphaltenes concentration using a NIR spectrophotometer (607). A computer (606) again may be use as a controller for the NIR (607). In some embodiments, the computer (606) may also receive the data from the NIR (607) and perform calculations using the data or report the date either locally or at a remote site.

In at least one embodiment of the disclosure, a near infrared spectrophotometer is employed. Any such spectrophotometer may be used with the method of the disclosure. For example, in one embodiment, an Ocean Optics USB2000 miniature fiber optic spectrophotometer is used. It applications where the measurements are made using an automated system, then a system incorporating an automatic cuvette may be selected.

Suitable automatic titrators useful with the method of the disclosure include any that can be adapted to work with a spectrophotometer. Exemplary automatic titrators include but are not limited to COM-550 manufactured by Hiranuma Sangyo Co., Ltd.; the Mettler DL22 titrator, and the Schott Universal titrator (EW-24906).

### EXAMPLES

The following examples are provided to illustrate the present invention. The examples are not intended to limit the scope of the present invention and they should not be so interpreted. Amounts are in weight parts or weight percentages unless otherwise indicated.

### Example 1

A sample visbreaker residuum is tested. 200 milligrams of residuum from a thermal cracking conversion process (visbreaking) were dissolved in 20 cc of heptane in order to precipitate asphaltenes fraction (heptanes insoluble) and stirred for 1 hour at 70° C. temperature. The solution for asphaltenes precipitation was left cooling down for 1 hour. The solution was then filtered on a 0.45 porosity syringe filter using a 10 mls glass syringe and filter was rinsed with heptane till complete disappearance of color.

The filter was then washed with using the syringe, of mixed solvents made of xylene/heptane mixtures. For each mixture of xylene/heptanes 20 mls of the solution were passed through the filter in order to recover a soluble asphaltenes fraction.

The following ratios of heptanes/xylene by volume were used: 15/85, 50/50, 40/60, 30/70, 20/80, 10/90 and 100 were used. Asphaltenes soluble in lower heptane/xylene ratio solutions and not extracted with higher ratios of heptanes are the less soluble and the more similar to coke. These are predicted by solubility (thermodynamics) to be the first fractions to phase separate at high temperature thermal cracking reactions (above 400° C.) to give coke.

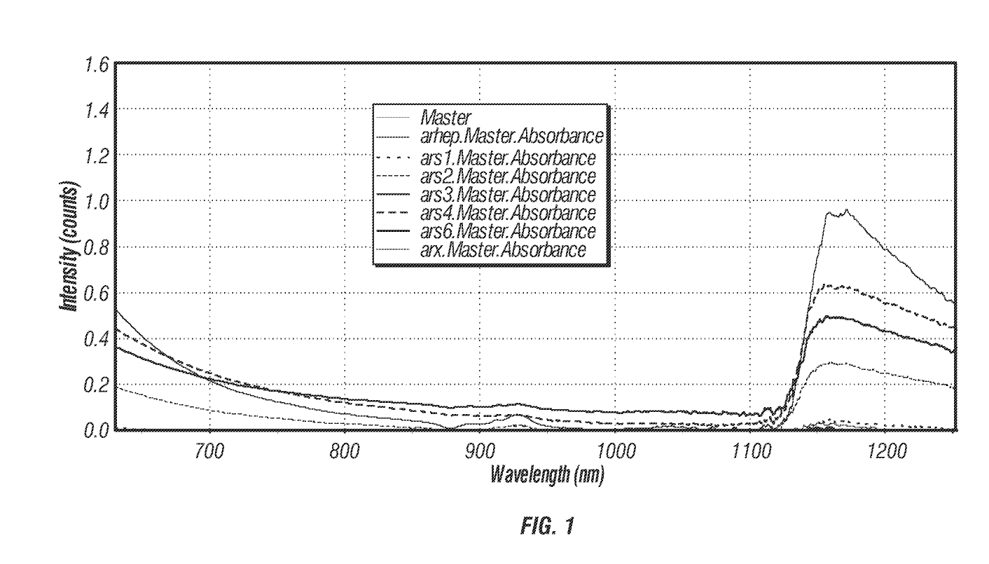

Each recovered fraction was analyzed by an Oceanoptics USB 2000 for the near infrared absorbance spectra (NIR) in the region between 630 and 1300 nm. Typical NIR spectra are presented in FIG. 1 below, showing absorbance, vs. wavelength.

Actual asphaltenes concentration in parts per million (ppm) was calibrated with the NIR spectra. Then, using the calibration curves were used to determine the content of asphaltenes in terms of ppm in each of the 20 mls solvent extracts.

The calibration was developed by dissolving weighted amounts of asphaltenes in xylene/heptane solutions, measuring spectra and correlating absorbances at different wavelengths against dissolved asphaltenes concentration. Absorbances at three wavelengths from 700 to 1250 nm were found to offer a very good linear multivariate regression of the type:

Predicted concentration, ppm=intercept+k1abs1+k2abs2+k3abs3

where k1,k2 and k3 are coefficients determined by regressing real concentration against predicted, in order to minimize the sum of squared differences between calibration sample concentration and predicted data (least square difference method). The value abs1, abs2 and abs3 are the absorbances at the three selected components.

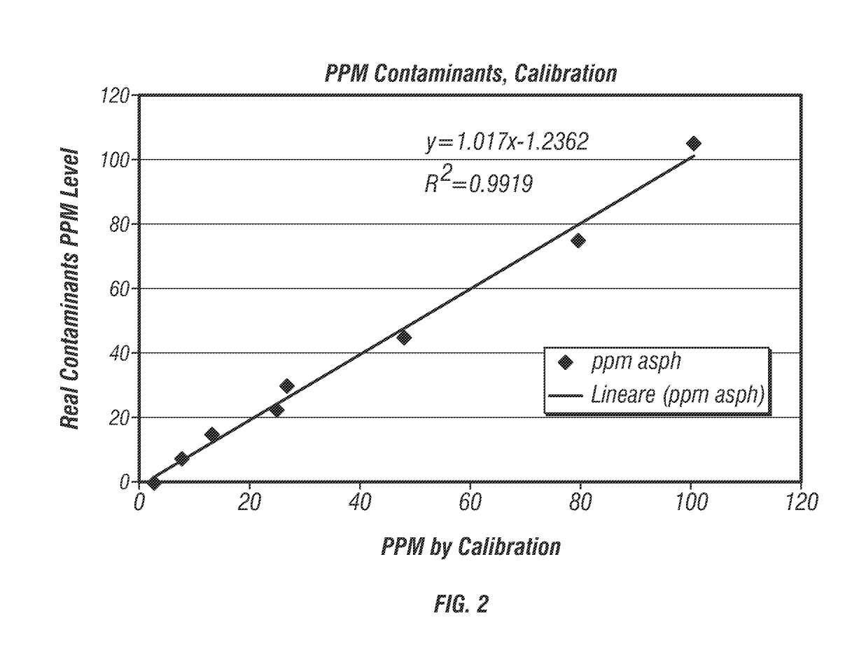

The good fitting of real vs. calculated values are presented in FIG. 2 in a typical correlation line.

After having determined the ppm concentration data were elaborated as shown below in Table 1:

TABLE 1

| | | | | | | | | total | |
|---|---|---|---|---|---|---|---|---|---|
| | | | | | | | | asphaltenes, | |
| | | | | | | | | ppm in 20 cc | asphaltenes |
| residuum feed, 200 mg | h/x 15:85 | h:x 50/50 | h:x 40/60 | h:x 30/70 | h:x 20/80 | h:x 10/90 | xylene | solvent | mg |
| ppm asphaltenes in 20 cc | 4 | 18 | 12 | 7 | 6 | 2 | 2 | 50.19 | 7.03 |
| % of the fraction respect | 8.58 | 35.18 | 23.13 | 13.29 | 11.92 | 4.84 | 3.06 | | |
| to total asphaltenes | | | | | | | | | |
| % asph respect to total | 0.30 | 1.24 | 0.81 | 0.47 | 0.42 | 0.17 | 0.11 | | |
| sample weight | | | | | | | | | |

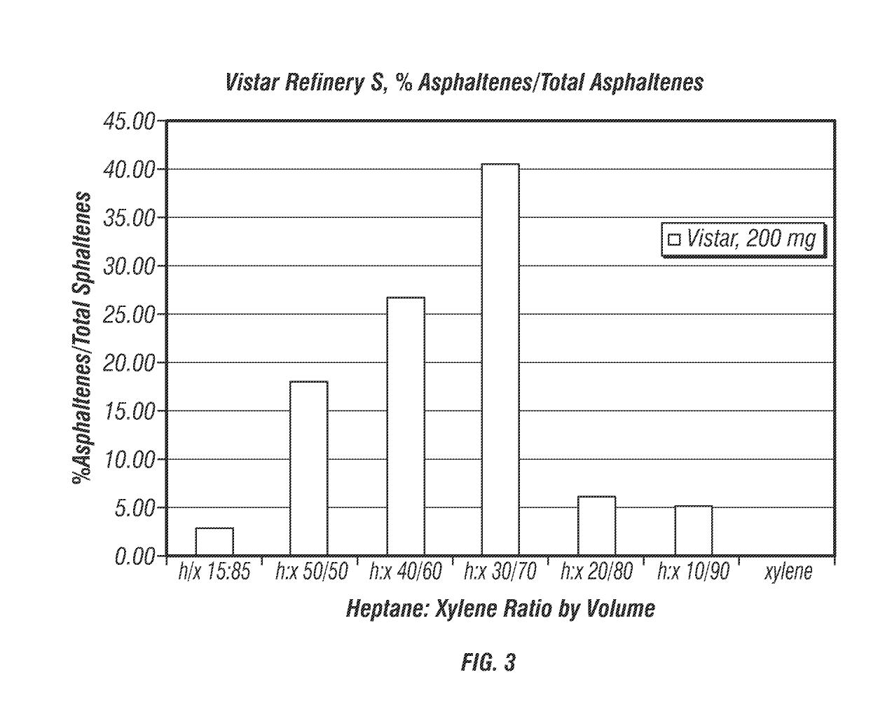

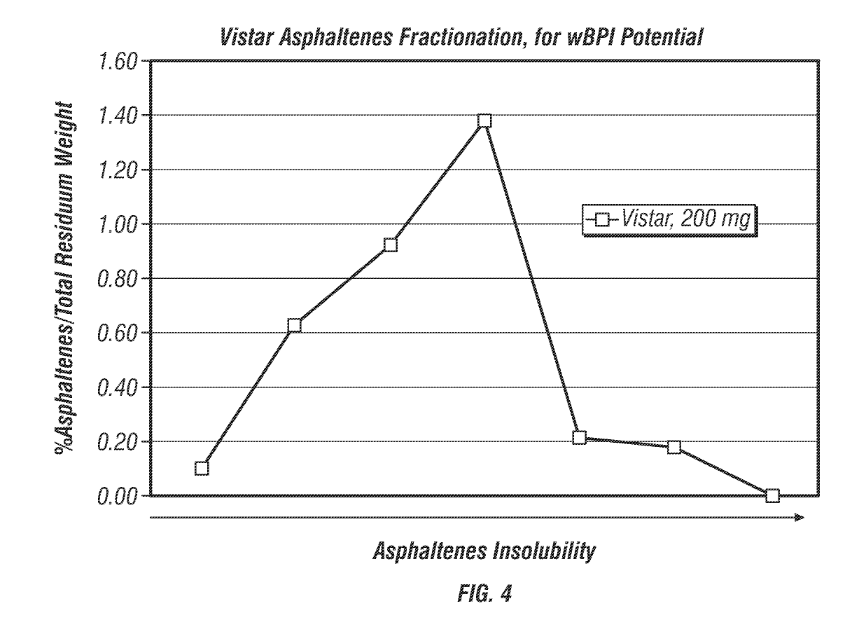

The data are presented in FIGS. 3 and 4.

### Example 2

A sample of Resid from a vacuum visbreaking unit is compared to resulting tar (VISTAR) produced during the visbreaking operation. 200 milligrams of residuum feeding a visbreaker unit were analyzed with same procedure as in Example 1 and results compared with the VISTAR obtained from this feed. Results are reported in the following table in Table 2.

TABLE 2

| | | | | | | | | total | |
|---|---|---|---|---|---|---|---|---|---|
| | | | | | | | | asphaltenes, | |
| | | | | | | | | ppm in 20 cc | asphaltenes |
| residuum feed, 200 mg | h/x 15:85 | h:x 50/50 | h:x 40/60 | h:x 30/70 | h:x 20/80 | h:x 10/90 | xylene | solvent | mg |
| ppm asphaltenes in 20 cc | 4 | 18 | 12 | 7 | 6 | 2 | 0 | 48.65 | 6.81 |
| % of the fraction respect | 8.85 | 36.29 | 23.86 | 13.71 | 12.30 | 4.99 | 0.00 | | |
| to total asphaltenes | | | | | | | | | |
| % asph respect to total | 0.30 | 1.24 | 0.81 | 0.47 | 0.42 | 0.17 | 0.00 | | |
| sample weight | | | | | | | | | |

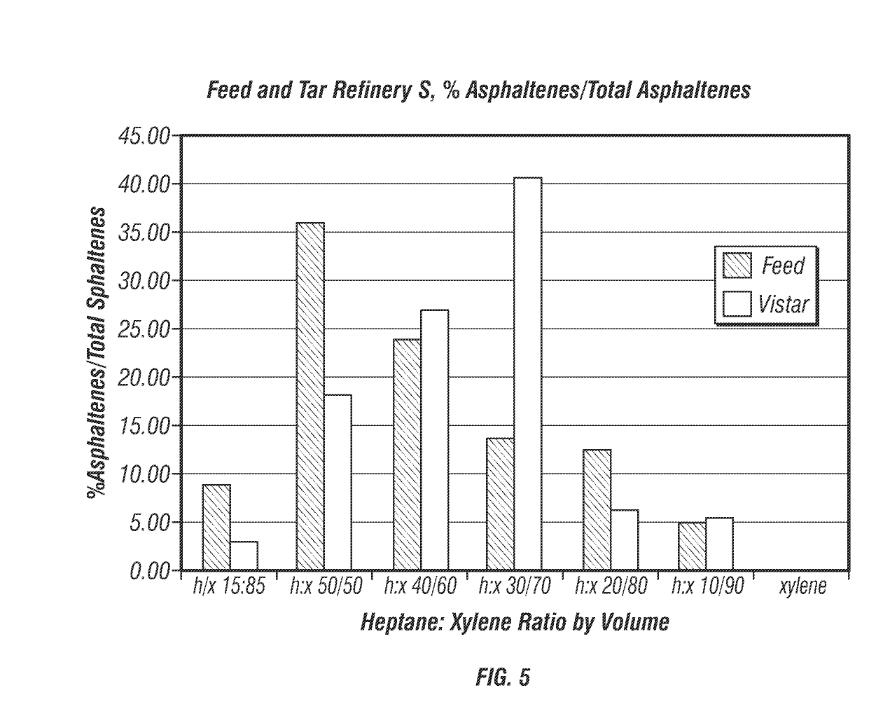

When compared with the feed, the VISTAR shows clearly an increase of asphaltenes that are less soluble, that is they require more xylene in the heptanes/xylene mixture in order to be solvated) with respect to the feed resid. This is clearly shown in FIG. 5.

What is claimed is:

1. A method for determining a coke generation tendency of hydrocarbons and using the coke generation tendency to control refining conditions comprising determining the coke generation tendency of the hydrocarbon using a near infrared spectrophotometer to analyze the concentration of asphaltenes in at least two solvent fractionation components of the hydrocarbon and then employing the coke generation tendency of the hydrocarbon to control a production unit which is processing the hydrocarbon.

2. The method of claim 1 wherein the employing the coke generation tendency of the hydrocarbon to control the production unit which is processing the hydrocarbon is accomplished using a predictive model.

3. The method of claim 1 wherein the employing the coke generation tendency of the hydrocarbon to control the production unit which is processing the hydrocarbon is accomplished using operator experience.

4. The method of claim 1 wherein the unit process parameters are changed, or not changed, based upon the results.

5. The method of claim 4 wherein the unit process parameters that are changed are selected from the group consisting of operating temperatures, flow rates, residence times, catalyst regeneration cycle times, and combinations thereof.

6. The method of claim 1 wherein the production unit is a cracking unit.

7. The method of claim 1 wherein the hydrocarbon is selected from the group consisting of heavy oils, petroleum residua, coal tars, shale oils, asphalts and combinations thereof.

8. The method of claim 1 wherein the determining the coke generation tendency of the hydrocarbon comprises:
admixing the hydrocarbon with a quantity of paraffinic solvent sufficient to fully precipitate asphaltenes present in the hydrocarbon;
collecting the precipitated asphaltenes; and
subjecting the precipitated asphaltenes to solvent fractionation.

9. The method of claim 8 additionally comprising employing a spectrophotometer to analyze the concentration of asphaltenes in a fractionating solvent.

10. The method of claim 8 wherein an automatic titrator is employed to dispense aliquots of fractionating solvent.

11. The method of claim 8 wherein a spectrophotometer and an automatic titrator are used and are networked using a controller.

12. The method of claim 11 wherein the controller is a personal computer.

13. The method of claim 12 wherein the method is run continuously.

14. The method of claim 4 wherein process parameters are not changed, but a hydrocarbon is diverted and not processed by the production unit.

15. The method of claim 14 wherein the hydrocarbon is treated with an additive and then processed.

16. An apparatus for determining the coke generation tendency of hydrocarbons comprising an automatic titrator configured to dispense solvent into a container configured to receive a sample, a near infrared spectrophotometer configured to analyze a fractionation solvent for asphaltenes concentration, a controller configured to accept data from at least the near infrared spectrophotometer.

17. The apparatus of claim 16 wherein the controller is a personal computer.

18. A method for determining a coke generation tendency of hydrocarbons and using the coke generation tendency to control refining conditions comprising admixing the hydrocarbon with a quantity of paraffinic solvent sufficient to fully precipitate asphaltenes present in the hydrocarbon;
collecting the precipitated asphaltenes; and
subjecting the precipitated asphaltenes to solvent fractionation
wherein the precipitated asphaltenes are subjected to solvent fractionation using an automatic titrator, a NIR spectrophotometer is used to determine the concentration of asphaltenes in the fractionation solvent, and the results of the spectrophotometer are transmitted to a processor which employs a predictive model to make a determination of the coke generation tendency of the hydrocarbon.

19. The method of claim 18 wherein the automatic titrator also transmits information to the processor regarding the fractionation solvent composition and volumes used.

20. The method of claim 19 wherein the results of the determination of the coke generation tendency of the hydrocarbon is performed on a non-transitory computer readable medium and the results are transmitted to an operator for the production unit.
